(19) United States
(12) Patent Application Publication
(10) Pub. No.: US 2023/0392092 A1
(43) Pub. Date: Dec. 7, 2023

(54) FUELS

(71) Applicant: Innospec Fuel Specialties LLC, Englewood, CO (US)

(72) Inventor: Alexander John Belly, Wilmington, DE (US)

(21) Appl. No.: 18/204,073

(22) Filed: May 31, 2023

Related U.S. Application Data
(60) Provisional application No. 63/347,723, filed on Jun. 1, 2022.

(30) Foreign Application Priority Data
Aug. 22, 2022 (GB) 2212201.4

(51) Int. Cl. C10L 10/14; C10L 1/08; C10L 1/14

(52) U.S. Cl. CPC C10L 10/14; C10L 1/08; C10L 1/143; C10L 2200/0476; C10L 2200/0469; C10L 2200/0446; C10L 2230/08; C10L 2250/04; C10L 2270/026

(57) ABSTRACT

The use of at least one wax anti-settling additive, optionally in combination with one or more further additives, to reduce the filter blocking tendency of a fuel composition having a tendency to block filters, wherein the fuel composition comprises a renewable diesel component and a biodiesel component.

The present invention relates to improvements in fuel compositions, and in particular to improving the properties of blended fuel compositions comprising renewable diesel and biodiesel.

Due to environmental considerations significant efforts have been made in developing alternative hydrocarbon fuels to fossil fuels to power internal combustion engines. The present invention relates in particular to alternatives to mineral diesel fuel.

One alternative fuel suitable for use in diesel engines is biodiesel. Biodiesel is produced by the transesterification of lipids obtained from plants or animals, for example tallow oil, soybean oil or other vegetable oil. Transesterification of the triglycerides obtained from these plant or animal sources with an alcohol such as methanol, ethanol or propanol produces a mono alkyl ester as the biodiesel fuel.

Renewable diesel is produced from biomass sources through biological, thermal and chemical processes. Typically renewable diesels are obtained by hydrotreatment of vegetable oils with hydrogen at elevated temperatures and pressures in the presence of a catalyst. Renewable diesel is sometimes referred to as hydrogenated vegetable oil.

Renewable diesel contains mainly saturated, predominantly straight chain, aliphatic hydrocarbons. Biodiesel consists primarily of mono alkyl esters. Mineral diesel often contains aromatic and sulfated species as well as aliphatic hydrocarbons.

Due to the different chemical components of the fuels, new challenges can arise when mineral diesel is replaced partially or fully with renewable diesel and/or biodiesel.

The present invention attempts to solve some problems that may occur when blends of renewable diesel and biodiesel are used. Due to the different chemical nature of the renewable and biodiesel components of a blended fuel, problems can occur when storing the fuel, particularly if storage is at low temperatures.

Three measurements are commonly taken to assess the low temperature performance of diesel fuel. Standardised tests have been devised to measure the temperature at which the fuel hazes (the cloud point—CP), the lowest temperature at which a fuel can flow (the pour point—PP) and the lowest temperature at which fuel flows through a filter, the cold filter plugging point—CFPP); and the changes thereto caused by additives (ACP, APP, ACFPP).

The present invention is not about the use of additives to change the cloud point, pour point or cold filter plugging point of a fuel. Rather the present invention seeks to address problems that can occur in a fuel when it is above the cloud point.

Diesel vehicle fuel systems are fitted with a filter to prevent particulate matter reaching the final injection system. If such particulates are not removed, failure of the fuel injection system could result.

Problems can arise when the filter becomes blocked as this affects the rate at which fuel is delivered to the engine. This issue is different to the problems which occur during cold filter plugging where wax forms under very low temperatures and blocks the filter until the wax re-dissolves. Filter blocking can occur due to the formation of particulates within the fuel, particularly during storage. In recent years the problems with filter blocking have become more prominent. This is because in an effort to reduce emissions and improve engine performance, more sophisticated injection systems have been developed. Since these fuel injection systems operate at high temperature and pressures they are more susceptible to wear and damage if exposed to particulates in the fuel. Fuel filter pore sizes have therefore decreased and in some cases may be as low as 2 to 5 microns in diameter. The reduction in pore size of the filter has inevitably led to increased issues with filter blocking. A blocked filter will restrict or prevent fuel from reaching an engine. This can cause problems with starting the engine and a loss of power.

In some instances a blocked filter can cause an engine to shut down altogether until the filter has been replaced, in order to protect the injection system, causing huge inconvenience to the user.

The present invention seeks to reduce the filter blocking tendency of fuels containing a blend of renewable diesel and biodiesel fuels. These fuels are different in nature to mineral diesel fuels and blends containing mineral diesel.

According to a first aspect of the present invention there is provided the use of at least one wax anti-settling additive, optionally in combination with one or more further additives, to reduce the filter blocking tendency of a fuel composition having a tendency to block filters, wherein the fuel composition comprises a renewable diesel component and a biodiesel component.

According to a second aspect of the present invention there is provided a method of reducing the filter blocking tendency of a fuel composition having a tendency to block filters and which comprise a biodiesel component and a renewable diesel component, the method comprising dosing into the fuel at least one wax anti-settling additive and optionally one or more further additives.

According to a third aspect of the present invention there is provided a fuel composition comprising a renewable diesel component, a biodiesel component, at least one wax anti-settling additive and optionally one or more further additives; wherein the fuel composition has a reduced filter blocking tendency compared with an otherwise identical fuel composition which does not comprise the wax anti-setting additive and has a tendency to block filters.

Preferred features of the first, second and third aspects of the invention will now be described.

The first, second and third aspects of the present invention relate to at least one wax anti-settling additive. This can involve one wax anti-settling additive or a mixture of two or more wax anti-settling additives. References herein to the wax anti-settling additive include embodiments in which two or more wax anti-settling additives are present.

The present invention relates to reducing the filter blocking tendency of fuel compositions comprising a biodiesel component and a renewable diesel component.

The fuel compositions may optionally further comprise a mineral diesel component. In preferred embodiments the fuel compositions do not comprise a mineral diesel component.

In this specification by biodiesel we mean to refer to esters of fatty acids. Such fuels are commonly referred to as first generation biodiesel. Biodiesel as defined herein contains esters of, for example, vegetable oils, animal fats and used cooking fats. This form of biodiesel may be obtained by transesterification of oils, with an alcohol, usually a monoalcohol, usually in the presence of a catalyst. The fatty acids used to produce the fuel may originate from a wide variety of natural sources including, but not limited to, vegetable oil, canola oil, safflower oil, sunflower oil, nasturtium seed oil, mustard seed oil, olive oil, sesame oil, soybean oil, corn oil, peanut oil, cottonseed oil, rice bran oil, babassu nut oil, castor oil, palm oil, rapeseed oil, low erucic acid rapeseed oil, palm kernel oil, lupin oil, jatropha oil, coconut oil, flaxseed oil, evening primrose oil, jojoba oil, camelina oil, tallow, beef tallow, butter, chicken fat, lard, dairy butterfat, shea butter, used frying oil, oil miscella, used cooking oil, yellow trap grease, hydrogenated oils, derivatives of the oils, fractions of the oils, conjugated derivatives of the oils, and mixtures of any thereof.

In this specification by renewable diesel we mean to refer to diesel fuel obtained by the hydrodeoxygenation of fats and oils. Such fuels are often referred to as second generation biodiesel and are derived from renewable resources such as vegetable oils and animal fats and processed, often in the refinery, using, for example, hydroprocessing such as the H-Bio process developed by Petrobras. Second generation biodiesel is marketed by ConocoPhillips as Renewable Diesel and by Neste as NExBTL. Renewable diesel fuels are sometimes known as hydrogenated vegetable oils (or HVOs).

The fuel composition comprises a renewable diesel component and a biodiesel component. Preferably the renewable diesel component makes up at least 10 vol % of all fuel components present in the composition, preferably at least 30 vol %, more preferably at least 40 vol %, preferably at least 50 vol %.

Suitably the renewable diesel component makes up at least 60 vol %, suitably at least 70 vol %, for example, at least 75 vol % of all fuel components in the fuel composition.

The renewable diesel component may provide up to 99 vol % of all fuel components present in the fuel composition, preferably up to 95 vol %, suitably up to 90 vol %, for example, up to 85 vol %.

The biodiesel component may make up at least 1 vol % of all fuel components present in the fuel composition, preferably at least 3 vol %, suitably at least 5 vol %, preferably at least 8 vol %, for example at least 10 vol %. The biodiesel component may make up at least 12 vol % of all fuel components present in the fuel composition, for example at least 15 vol %.

The biodiesel component may provide up to 90 vol % of all fuel components present in the fuel composition, for example up to 70 vol %, suitably up to 50 vol %, for example up to 40 vol % or up to 30 vol %. The biodiesel component may provide up to 25 vol % of all fuel components present in the fuel composition.

In some preferred embodiments, the fuel composition comprises from 1 to 40 vol %, preferably 5 to 35 vol % of a biodiesel component and from 60 to 99%, preferably 65 to 95 vol % of a renewable diesel component.

In some further preferred embodiments, the fuel composition comprises from 10 to 30 vol %, preferably 15 to 25 vol % of a biodiesel component and from 70 to 90 vol %, preferably from 75 to 85 vol % of a renewable diesel component.

In some especially preferred embodiments, the fuel composition is a blended fuel comprising approximately 80 vol % of a renewable diesel component and approximately 20 vol % of a biodiesel component.

Preferably the fuel composition comprises less than 10 vol % mineral diesel, preferably less than 5 vol %, more preferably less than 3 vol %, preferably less than 1 vol %, for example less than 0.5 vol % or less than 0.1 vol % mineral diesel.

In some embodiments the fuel composition may comprise trace amounts of mineral diesel. Such trace amounts may be present due to contamination of the fuel composition during transport and/or storage using pipelines and/or tanks that previously contained mineral diesel.

In especially preferred embodiments, the fuel composition does not comprise a mineral diesel component.

In the present invention the filter blocking tendency of the fuel compositions comprising a biodiesel component and a renewable diesel component is reduced by the addition of a wax anti-settling additive and optionally one or more further additives.

Preferably the wax anti-settling additive is selected from one or more of:
(a) the reaction product of a polycarboxylic acid having at least one tertiary amino group and a primary or secondary amine;
(b) the reaction product of an α, β dicarboxylic acid or a derivative thereof and a primary amine;
(c) the reaction product of a polyamine and a fatty acid;
(d) the reaction product of secondary amines and a copolymer of maleic anhydride and an α-olefin;
(e) the reaction product of an anhydride of a polycarboxylic acid and at least two equivalents of secondary amine;
(f) a spirobislactone derivative; and
(g) a Mannich modified alkylphenol aldehyde resin.

Additives of this type are known in the art as wax anti-settling additives (WASAs). In some embodiments the wax anti-settling additive comprises (a) the reaction product of a polycarboxylic acid having at least one tertiary amino group and a primary or secondary amine.

The polycarboxylic acid having at least one tertiary amino group preferably has 2 to 20 carbon atoms, at least one tertiary amino group and 2 to 12 carboxylic acid groups. Each carboxylic acid group in the polycarboxylic acid preferably has from 2 to 10 carbon atoms. The polycarboxylic acid groups may be the same or different. Preferably each carboxylic acid group is an acetic acid group. The polycarboxylic acid preferably has from 1 to 3 tertiary amino groups and from 2 to 8 carboxylic acid groups. In preferred embodiments the polycarboxylic acid has 3 to 5, preferably 3 or 4 carboxylic acid groups and 1 to 3, preferably 1 or 2 tertiary amino groups.

In some preferred embodiments the polycarboxylic acid has the formula (1) or (II):

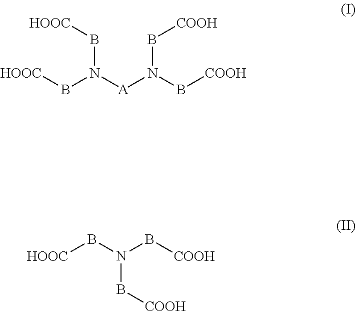

wherein A is a straight chain or branched C₂-C₆ alkylene group or HOOC—B—N(CH₂CH₂)₂ and B is a C₁ to C₉ alkylene group.

Preferably A has 2 to 4 carbon atoms, more preferably 2 or 3 carbon atoms, most preferably 2 carbon atoms.

Preferably B has 1 to 10, more preferably 1 to 4 carbon atoms.

Preferred carboxylic acids used to prepare additive (a) include nitrilotriacetic acid, ethylenediamine tetraacetic acid and propylene-1,2-diamine tetraacetic acid.

To form additive (a) the polycarboxylic acid is reacted with a primary or secondary amine. Most preferably the polycarboxylic acid is reacted with a secondary amine, preferably a secondary amine of formula HNR₂ in which each R is independently a straight chain or branched C₁₀ to C₃₀ alkyl or alkenyl group, preferably a C₁₄ to C₂₄ alkyl or alkenyl group. Preferably each R is an alkyl group. Preferably each R is the same.

The secondary amines may react with the polycarboxylic acid to form an amide and/or an ammonium salt. In preferred embodiments all of the amines react to form amides.

Preferred amines for reaction with the polycarboxylic acid include dioleylamine, dipamitylamine, dicoconut fatty amine, distearylamine, dibehenyl amine and hydrogenated and/or unhydrogenated ditallow fatty amine. Ditallow fatty amine is especially preferred. Preferably hydrogenated ditallow fatty amine.

The skilled person will appreciate that natural sources of fatty amines often contain a mixture of compounds, for example a mixture of isomers and/or a mixture of homologues.

Preferably the amines are reacted with the carboxylic acid in a ratio of from 0.5 to 1.5, preferably from 0.8 to 1.2 moles of amine per carboxylic group present in the carboxylic acid.

An especially preferred additive component (a) is the reaction product of 1 mole of ethylenediamine tetraacetic acid and 4 moles of hydrogenated ditallow fatty amine.

In some embodiments the wax anti-settling additive comprises (b) the reaction product of an α, β unsaturated dicarboxylic acid or a derivative thereof and a primary amine. The skilled person will appreciate that such reaction products may comprise one or two amides, an imide, a salt or a mixture thereof.

Preferred α, β dicarboxylic acids for use in preparing additives (b) include succinic acid, maleic acid, fumaric acid, itaconic acid and derivatives thereof. Such acids may be substituted. By derivatives of α, β dicarboxylic acid we mean to include carbonyl halides, carboxylic esters and carboxylic anhydrides. In some preferred embodiments the α, β dicarboxylic acid derivative is an anhydride. Most preferably component (b) is the reaction product of maleic anhydride and a primary amine.

Preferred primary amines for reaction with the α, β unsaturated dicarboxylic acid are alkyl, alkenyl, aryl, alkaryl or aralkyl amines, preferably having 8 to 30, more preferably 12 to 22 carbon atoms. Preferred amines are alkyl or alkenyl amines. The alkyl or alkenyl chain may be straight-chained or branched, saturated or unsaturated. A mixture of alkyl or alkenyl amines may be used. The skilled person will appreciate that commercial sources of such amines often comprise a mixture of isomers and/or a mixture of homologues. In some preferred embodiments natural sources of fatty amines are used for example coconut amine, tallow fatty amine, hydrogenated tallow fatty amine, oleyl amine, arachidyl amine and behenyl amine.

Additive component (b) preferably comprises a monoamide or bisamide of maleic acid. Component (b) may also comprise minor amounts of the ammonium salt.

In one preferred embodiment component (b) comprises the reaction product of 1 mole of maleic anhydride and 1 mole of a C₁₃ alkyl amine.

In some embodiments the wax anti-settling additive may comprise (c) the reaction product of a polyamine and a fatty acid.

Preferred polyamines are polyethylene polyamines. Examples of suitable polyamines which may be used to prepare the amines of component (c) include ethylenediamine, diethylene triamine, triethylenetetraamine, tetraethylenepentamine, pentaethylenehexamine, dipropylenetriamine, tripropylenetetramine, tetrapropylenepentamine, pentapropylenehexamine, polyethylene imines having a mean degree of polymerisation (numbers of nitrogen atoms) of 10, 35, 50 or 100 and polyamines obtained by reacting a oligoamines with acrylonitrile and subsequent hydrogenation, for example N,N′bis-(3-amino propyl) ethylene diamine.

Suitable fatty acids for reaction with the polyamines include pure fatty acids and commercial sources comprising mixtures of fatty acids including, for example, stearic acid, palmitic acid, lauric acid, oleic acid, linolic acid and linoleic acid. Especially useful for preparing component (c) are mixtures of naturally occurring fatty acids, for example tallow fatty acid, coconut fatty acid, fish oil fatty acid, coconut palm kernel oil fatty acid, soybean oil fatty acid, colza oil fatty acid, peanut oil fatty acid and palm oil fatty acid. Compounds including monoesters of long chain alcohols and dicarboxylic acids can also be used as the fatty acid component.

Preferably component (c) is prepared from polyethylene polyamines having 2 to 6 nitrogen atoms and fatty acids having 16 to 20 carbon atoms.

In one preferred embodiment component (c) comprises the reaction product of 3 moles of oleic acid with 1 mole of diethylenetriamine.

In some embodiments the wax anti-settling additive comprises (d) the reaction product of secondary amines and a copolymer of an α,β-unsaturated dicarboxylic anhydride and an α-olefin.

Preferred compounds of this type are copolymers based on α,β-unsaturated dicarboxylic anhydrides, α,β-unsaturated compounds and optionally polyoxyalkylene ethers of lower unsaturated alcohols, which comprise:
a) 20-80 mol % of bivalent structural units A1 and/or A2

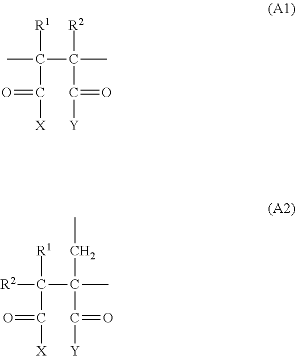

wherein R¹ and R² are, independently of one another, hydrogen or methyl,
X and Y are identical or different groups and selected from and N—HR³ group wherein R³ is C₆-C₄₀-alkyl, C₅-C₂₀-cycloalkyl or C₆-C₁₈-aryl; an N—(R³)₂ group wherein each R³ is identical or different and is as defined above; and an OR⁴ group wherein R⁴ is hydrogen, a cation of the formula H₂N⁺(R³)₂ or H₃N⁺R³, C₆-C₄₀-alkyl, C₅-C₂₀-cycloalkyl or C₆-C₁₈-aryl;
b) 19-80 mol % of bivalent structural units D

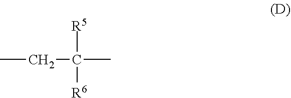

in which R⁵ is hydrogen or C₁-C₄-alkyl and R⁶ is C₆-C₆₀-alkyl or C₆-C₁₈-aryl; and
c) 0-30 mol % of bivalent structural units E

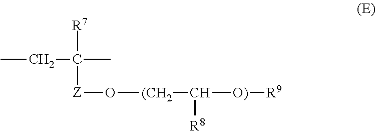

in which R⁷ is hydrogen or methyl, R⁸ is hydrogen or C₁-C₄-alkyl, Z is C₁-C₄-alkylene m is a number from 1 to 100, R⁹ is C₁-C₂₄-alkyl, C₅-C₂₀-cycloalkyl, C₆-C₁₈-aryl or —C(O)—R¹⁰, wherein R¹⁰ is C₁-C₄₀-alkyl, C₅-C₁₀-cycloalkyl or C₆-C₁₈-aryl.

As will be appreciated by the skilled person, the copolymer may comprise small amounts of unopened anhydride or imide structural units derived from the α,β-unsaturated dicarboxylic anhydride structural units A1 and/or A2.

Preferred copolymers do not contain structural units E. In preferred embodiments X is a group of formula N—(R³)₂ wherein R³ is C₆-C₄₀ alkyl and Y is a group of the formula OR⁴, wherein R⁴ is a cation of formula H2N⁺(R³)₂ wherein R³ is C₆-C₄₀ alkyl.

Preferred wax anti-settling additives (d) are derived from copolymers of maleic anhydride and an α-olefin having 6 to 30 carbon atoms reacted with 2 equivalents of a fatty amine.

An especially preferred compound (d) is prepared from a copolymer of maleic anhydride and a C18 α-olefin reacted with 2 equivalents of ditallow fatty amine.

In some embodiments the wax anti-settling additive comprises (e) the reaction product of an anhydride of a polycarboxylic acid and at least two equivalents of secondary amine.

Suitable wax anti-settling additives (e) have a total of 30-300, preferably 50-150 carbon atoms and are oil-soluble amine salts and amides formed by reacting at least 1 molar portion of a hydrocarbyl substituted amine with 1 molar portion of an anhydride of an aromatic or cycloaliphatic polycarboxylic acid, having e.g. 2 to 4 carboxyl groups, preferably dicarboxylic acid anhydrides.

The amines may be primary, secondary, tertiary or quaternary, but preferably are secondary. Tertiary and quaternary amines can only form amine salts. Examples of amines include tetradecyl amine, cocoamine, hydrogenated tallow amine and the like. Examples of secondary amines include cocomethyl amine, dioctadecyl amine, methyl-behenyl amine and the like. Amine mixtures are also suitable and many amines derived from natural materials are mixtures. The preferred amine is a secondary hydrogenated tallow amine of the formula HNR¹R² wherein R¹ and R² are alkyl groups derived from tallow fat composed of approximately 4% C14, 31% C16, 59% C18.

Examples of suitable carboxylic acids (and their anhydrides) include cyclohexane dicarboxylic acid, cyclohexene dicarboxylic acid, cyclopentane dicarboxylic acid, naphthalene dicarboxylic acid, and the like. Generally these acids will have about 5-14 carbon atoms in the cyclic moiety. Preferred acids useful in the present invention are benzene dicarboxylic acids such as phthalic acid, terephthalic acid, and isophthalic acid.

Preferred compounds of this type have at least one straight chain alkyl segment extending from the compound containing 8-40 preferably 14-24 carbon atoms. Preferably the compound contains at least three alkyl chains each containing from 8 to 40 carbon atoms and at least one ammonium salt, amine salt or amide linkage.

One particularly preferred compound is the amide-amine salt formed by reacting 1 molar portion of phthalic anhydride with 2 molar portions of hydrogenated ditallow fatty amine.

Another preferred compound is the reaction product pyromellitic anhydride and 4 equivalents of a secondary amine, particularly hydrogenated ditallow fatty amine.

In some embodiments the wax anti-settling additive comprises (f) a spirobislactone derivative.

Preferred compounds of this type are the reaction products of an amine of formula NR¹R²R³ and an alkenyl-spirobislactone of formula

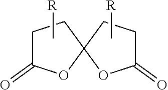

in which R is in each case C₈-C₂₀₀-alkenyl, and R¹, R² and R³ are identical or different and at least one of these groups R¹, R² and R³ is C₈-C₃₆-alkyl, C₈-C₃₆-alkenyl or cyclohexyl and the other groups are hydrogen or a group of the formula -(A-O)ₓH or —(CH₂)ₙ—NYZ, A is C₂H₄ and/or C₃H₅, x is a number from 1 to 20, n is 2 or 3 and Y and Z are identical or different and are hydrogen or a group of formula (-A-O)ₓH.

Preferred wax anti-settling additives (f) include the reaction product of 1 mole of alkenyl-spirobislactone with 2 moles of a dialkylamine, for example ditallow fatty amine (hydrogenated or un hydrogenated).

In some embodiments the wax anti-settling additive comprises (g) a Mannich modified alkylphenol aldehyde resin.

Mannich modified alkylphenol aldehyde resins can be obtained by a Mannich reaction of an alkylphenol aldehyde resin with at least one aldehyde and/or one ketone having 1 to 8 carbon atoms, preferably having 1 to 4 carbon atoms; and at least one compound having at least one alkylmonoamine or alkylpolyamine group (i.e. having several amine groups) having between 4 and 30 carbon atoms, called hereafter alkylamine. The alkylphenol aldehyde resin can itself be obtained by condensation of at least one alkylphenol substituted by at least one linear or branched alkyl group having 1 to 30 carbon atoms, preferably a monoalkylphenol,

with at least one aldehyde and/or one ketone having 1 to 8 carbon atoms, preferably 1 to 4 carbon atoms.

The alkylphenol-aldehyde resins are known per se and can be obtained from at least one alkylphenol substituted in para position; preferably nonylphenol. The average number of phenolic nuclei per molecule of preferred nonylphenol-aldehyde resin is preferably 6 to 25, more preferably 8 to 17 or 9 to 16, and can be determined by NMR or GPC.

The Mannich modified alkylphenol aldehyde resins obtained from at least one aldehyde and/or one ketone chosen from formaldehyde, acetaldehyde, propionaldehyde, butyraldehyde, 2-ethyl hexanal, benzaldehyde, acetone, preferably formaldehyde; and at least one alkylamine having at least one primary amine group, and advantageously at least one compound, all the amine groups of which are primary amines. According to a preferred embodiment, the Mannich modified alkylphenol-aldehyde resins can be obtained from at least one alkylamine with an aliphatic chain having between 12 and 24 carbon atoms, preferably between 12 and 22 carbon atoms. According to a particularly preferred embodiment, the Mannich modified alkylphenol-aldehyde resins according to the invention can be obtained from at least one alkylamine having at least one primary amine group and comprising an aliphatic chain having between 12 and 24 carbon atoms, preferably between 12 and 20 carbon atoms.

Further preferred features of compounds of this type are described, for example, in U.S. Pat. No. 9,169,452.

In some embodiments the wax anti-settling additive comprises component (a).

In some embodiments the wax anti-settling additive comprises component (b).

In some embodiments the wax anti-settling additive comprises component (c).

In some embodiments the wax anti-settling additive comprises component (d).

In some embodiments the wax anti-settling additive comprises component (e).

In some embodiments the wax anti-settling additive comprises component (f).

In some embodiments the wax anti-settling additive comprises component (g).

In some preferred embodiments the wax anti-settling additive comprises one or more of component (a), component (b), component (c) and component (d).

In some preferred embodiments the wax anti-settling additive comprises two or more of component (a), component (b), component (c), component (d), component (e), component (f) and component (g).

The wax anti-settling additive is suitably present in the fuel composition in an amount of at least 1 ppm, preferably at least 2 ppm, suitably at least 5 ppm.

The wax anti-settling additive may be present in the fuel composition in an amount of up to 1000 ppm, suitably up to 750 ppm, for example up to 500 ppm.

Preferably the wax anti-settling additive is present in the fuel composition an amount of from the 1 to 1000 ppm, preferably 2 to 500 ppm, for example 5 to 250 ppm.

For the avoidance of doubt when the fuel composition comprises a mixture of two or more wax anti-settling additives, the above amounts refer to the total amount of all wax anti-settling additives present in the composition. Unless otherwise stated, all references to ppm in this specification are to parts per million by weight.

According to the present invention one or more further additives may be used with the wax anti-settling additive to provide the reduced filter blocking tendency.

In some preferred embodiments the one or more further additives include a copolymer obtained by reacting monomers of:
(x) an α-olefin;
(y) an ester of an unsaturated alcohol; and optionally
(z) a third monomer different to (x) and (y) comprising an alkene functional group.

Each of monomers (x), (y) and (z) may comprise a mixture of compounds, for example a mixture of isomers and/or a mixture of homologues.

Monomer component (x) is an α-olefin. Suitable α-olefins include ethylene, propylene, 1-butene, 1-pentene, 1-hexene, 1-heptene, 1-octene, 1-nonene, 1-decene and higher monounsaturated homologues having up to 40 carbon atoms. Preferably the α-olefin component (x) is selected from ethylene, propylene and 1-butene, more preferably from ethylene and propylene. Most preferably component (x) comprises ethylene.

Monomer (y) is the ester of an unsaturated alcohol. The term unsaturated alcohol is meant to refer to an alcohol including a double bond. Preferably the alcohol includes one double bond. Preferably the double bond is adjacent to the hydroxy functional group. In preferred embodiments the ester of an unsaturated alcohol is a vinyl ester.

Preferred esters are esters of C₁ to C₂₀ carboxylic acids, especially vinyl esters of acetic acid, propionic acid, butyric acid, valeric acid, isovaleric acid, pivalic acid, caproic acid, enanthic acid, caprylic acid, pelargonic acid, neononanoic acid, neodecanoic acid, capric acid, lauric acid, myristic acid, palmitic acid, stearic acid and arachidic acid. Propenyl esters of such acids could also be used.

In particular preferred embodiments the monomer (y) is a vinyl ester of acetic acid, also referred to as vinyl acetate.

In some embodiments the copolymer is prepared only from monomers (x) and (y) and the copolymer is an ethylene vinyl acetate (or EVA) copolymer. Compounds of this type are well known to those skilled in the art. Suitable EVA copolymers for use herein are described, for example, in U.S. Pat. No. 3,048,479, GB1263152 and U.S. Pat. No. 3,961,916.

In some embodiments the copolymer is a terpolymer obtained by reacting monomers of (x), (y) and (z).

Monomer (z) is different to (x) and (y) and comprises an alkene functional group. By this we mean that monomer (z) comprises a double bond. Preferably monomer (z) comprises a single double bond.

In some embodiments monomer (z) comprises an ester including a double bond. The double bond may be present in the alcohol derived portion of the ester or in the acid derived portion of the ester.

In some embodiments (z) may comprise an alkene. In some embodiments (z) may comprise an ester of an unsaturated alcohol which is different to monomer (x).

Preferably monomer (z) is selected from:
an alkene, especially an α-olefin;
an α,β unsaturated carboxylic acid or an ester thereof; and
an ester of an unsaturated alcohol.

In some embodiments the polymer may be prepared from a mixture of monomers (z).

In some embodiments monomer (z) comprises an alkene, especially an α-olefin which is different to component (x). Suitable α-olefins include propylene, 1-butene, 1-pentene, 1-hexene, 1-heptene, 1-octene, 1-nonene, 1-decene and higher monounsaturated homologues having up to 40 carbon atoms.

In one preferred embodiment where component (x) comprises ethylene, component (z) comprises propylene.

In some embodiments components (z) comprises an α, β unsaturated carboxylic acid or an ester thereof. Preferred monomers are esters of an α,β unsaturated carboxylic acid. Suitable α, β unsaturated acids which may be used to prepare monomer (z) include acrylic acid, methacrylic acid, crotonic acid and isocrotonic acid. Preferred monomers are esters of such acids and C₁ to C₂₀ alcohols.

In some preferred embodiments the monomer (z) is selected from methyl acrylate, ethyl acrylate, propyl acrylate, isopropyl acrylate, n-butyl acrylate, isobutyl acrylate, tert-butyl acrylate, n-pentyl acrylate, neopentyl acrylate, heptyl acrylate, octyl acrylate, neooctyl acrylate, 2-ethylhexyl acrylate, nonyl acrylate, neononyl acrylate, decyl acrylate, neodecyl acrylate, lauryl acrylate, palmityl acrylate and stearyl acrylate.

Preferred monomers (z) include methyl acrylate and 2-ethylhexyl acrylate.

In one preferred embodiment component (z) comprises 2-ethylhexyl acrylate.

In some embodiments component (z) comprises an ester of an unsaturated alcohol which is different to monomer (y).

In such embodiments component (z) is preferably a vinyl ester of a fatty acid having linear or branched alkyl groups having 1 to 30 carbon atoms and especially having 1 to 18 carbon atoms. Examples include vinyl acetate, vinyl propionate, vinyl butyrate, vinyl hexanoate, vinyl heptanoate, vinyl octanoate, vinyl laurate and vinyl stearate, and also esters of vinyl alcohol based on branched fatty acids, such as vinyl isobutyrate, vinyl pivalate, vinyl 2-ethylhexanoate, vinyl isononanoate, vinyl neononanoate, vinyl neodecanoate and vinyl neoundecanoate.

In one preferred embodiment component (z) comprises a vinyl ester of neononanoic acid.

Some preferred terpolymers are formed from ethylene, vinyl acetate and vinyl neononanoate or from ethylene, vinyl acetate and vinyl neodecanoate or from ethylene, vinyl acetate and vinyl neoundecanoate or from ethylene, vinyl acetate and vinyl 2-ethylhexanoate. Particularly preferred terpolymers of vinyl neononanoate, of vinyl neodecanoate, of vinyl neoundecanoate and of vinyl 2-ethylhexanoate contain, apart from ethylene, 7.7 to 15.9 mol %, particularly 9.5 to 15.4 mol % and especially 10.0 to 15.0 mol %, for example 10.5 to 15.0 mol % of vinyl acetate and 0.1 to 6 mol %, particularly 0.2 to 5 mol % and especially 0.3 to 5 mol % of the respective long-chain vinyl ester, where the total comonomer content is between 8.0 and 16.0 mol %, particularly between 10.0 and 15.5 mol % and especially between 10.5 and 15.0 mol %, for example between 10.5 and 14.5 mol %.

(Meth)acrylic esters suitable as comonomers are esters of acrylic acid and methacrylic acid and preferably those having 1 to 20 carbon atoms in the alkyl radical, such as methyl (meth)acrylate, ethyl (meth)acrylate, n- and isopropyl (meth)acrylate, n- and isobutyl (meth)acrylate, hexyl, octyl, 2-ethylhexyl, decyl, dodecyl, tetradecyl, hexadecyl, octadecyl (meth)acrylate. Also suitable are mixtures of two, three, four or more of these comonomers. In a preferred embodiment, terpolymers of ethylene, a vinyl ester and a (meth)acrylic ester, for example terpolymers of ethylene, vinyl acetate and methyl acrylate, of ethylene, vinyl acetate and isobutyl acrylate or of ethylene, vinyl acetate and 2-ethylhexyl acrylate may be used. Particularly preferred terpolymers contain, apart from ethylene, 1 to 20 mol %, particularly 2 to 18 mol % and especially 5 to 15 mol %, for example 8 to 12 mol % of vinyl acetate and 0.1 to 10 mol %, particularly 2 to 8 mol % and especially 4 to 6 mol % of the particular (meth)acrylic ester, where the total comonomer content is between 5 and 30 mol %, particularly between 10 and 20 mol % and especially between 12 and 18 mol %, for example between 13 and 17 mol %.

Further preferred terpolymers contain, as well as ethylene and 8.0 to 17 mol %, more preferably 10 to 16.0 mol % and especially 10.5 to 15.5 mol %, for example 10.5 to 15.0 mol %, of one or more vinyl esters, also 0.1 to 5 mol % and preferably 0.2 to 4 mol % of one or more olefins having 3 to 8 carbon atoms, for example propene, butene, isobutylene, hexene, 4-methylpentene, octene, diisobutylene and/or norbornene, in which case the molar content thereof is subtracted from the molar ethylene content. A preferred olefin is propene. Particularly preferred terpolymers of ethylene, one or more vinyl esters and propene have 0.5 to 4.0 methyl groups derived from propene per 100 aliphatic carbon atoms. The number of methyl groups derived from propene (propene CH3) per 100 aliphatic carbon atoms is determined by means of ¹³C NMR spectroscopy.

The terpolymers preferably have number-average molecular weights Mn between 1000 and 7000 g/mol and especially between 1200 and 5000 g/mol. The weight-average molecular weight is preferably between 2000 and 20 000 g/mol, more preferably between 3000 and 15 000 g/mol and especially between 3500 and 12 000 g/mol, in each case determined by means of gel permeation chromatography (GPC) in THF against poly(styrene) standards. The molecular weight of the copolymers can also be characterized via their melt viscosity; the melt viscosity of preferred copolymers measured at 140° C. (without solvent) is preferably between 20 and 5000 mPas, particularly between 30 and 2000 mPas and especially between 50 and 1500 mPas.

Some preferred copolymers for use herein include terpolymers of ethylene, vinyl acetate and propene; of ethylene, vinyl neononanoate and propene; of ethylene, vinyl neodecanoate and propene; of ethylene, vinyl 2-ethylhexanoate and propene; and of ethylene, vinyl acetate and 2-ethylhexylacrylate.

Preferred copolymers include the polymers described in U.S. Pat. Nos. 7,713,316, 6,306,186, 8,642,521, 7,815,697 and US2017/0233670.

The copolymer, when present, is suitably included in the fuel composition in an amount of at least 1 ppm, preferably at least 5 ppm, suitably at least 10 ppm.

The copolymer, when present, is suitably included in the fuel composition in an amount of up to 1000 ppm, suitably up to 750 ppm, for example up to 500 ppm.

Preferably the copolymer, when present, is suitably included in the fuel composition an amount of from the 1 to 1000 ppm, preferably 5 to 500 ppm, for example 10 to 250 ppm.

Other further additives which may, in combination with the wax anti-settling additive, reduce the filter blocking tendency of the fuel compositions include alkylphenol aldehyde resins.

Suitably alkylphenol aldehyde resins are known to the person skilled in the art. They are described, for example, in Rompp Chemie Lexikon (Rompps Chemistry Lexicon), 9th edition, Thieme Verlag 1988-92, Volume 4, pp. 3351ff.

The alkyl radicals of the o- or p-alkylphenol have 1-20, preferably 4-16, in particular 6-12 carbon atoms; they are preferably n-, tert- and isobutyl, n- and isopentyl, n- and isohexyl, n- and isooctyl, n- and isononyl, and n- and isodecyl, n- and isododecyl. The alkylphenol-aldehyde can also comprise up to 50 mol % of phenol units. For the alkylphenol-aldehyde resin, identical or different alkylphenols can be used. The aliphatic aldehyde in the alkylphenol-aldehyde resin B has 1-4 carbon atoms and is preferably formaldehyde. The molecular weight of the alkylphenol-aldehyde resins is suitably 400-10,000, preferably 400-5000, g/mol. Preferably the resins are oil-soluble.

The alkylphenol aldehyde resins may be prepared in a known manner by base catalysis, condensation products of the resol type being formed, or by acid catalysis, condensation products of the novolak type being formed. The alkylphenol aldehyde resins produced in both ways are suitable for use herein. Preferred are those prepared by condensation in the presence of acid catalysts.

To prepare the alkylphenol aldehyde resins, a bifunctional o- or p-alkylphenol having 1 to 20 carbon atoms, preferably 4 to 16, in particular 6 to 12, carbon atoms per alkyl group, or mixtures thereof, and an aliphatic aldehyde having 1 to 4 carbon atoms are reacted together, about 0.5-2 mol, preferably 0.7-1.3 mol, and in particular equimolar amounts, of aldehyde being used per mol of alkylphenol compound.

Suitable alkylphenols are, in particular, C4-C12-alkylphenols such as o- or p-cresol, n-, sec- and tert-butylphenol, n- and isopentyl phenol, n- and isohexylphenol, n- and isooctylphenol, n- and isononylphenol, n- and isodecylphenol, n- and isododecylphenol.

The alkylphenols to be used can include small amounts, preferably up to about 10 mol %, in particular up to 7 mol %, and especially up to 3 mol %, of dialkylphenols.

Particularly suitable aldehydes are formaldehyde, acetaldehyde and butyraldehyde; preference is given to formaldehyde or reactive equivalents thereof.

The formaldehyde can be used in the form of paraformaldehyde or in the form of a preferably 20-40% strength by weight aqueous formaline solution. Corresponding amounts of trioxane can also be used.

Further preferred features of alkylphenol aldehyde resins suitable for use herein and methods of preparing such compounds are described in U.S. Pat. No. 5,998,530.

The alkyl phenol resin, when present, is suitably included in the fuel composition in an amount of at least 0.1 ppm, preferably at least 0.5 ppm, suitably at least 1 ppm.

The alkyl phenol resin, when present, is suitably included in the fuel composition in an amount of up to 500 ppm, suitably up to 250 ppm, for example up to 100 ppm.

Preferably the alkyl phenol resin, when present, is suitably included in the fuel composition an amount of from the 0.1 to 500 ppm, preferably 0.5 to 250 ppm, for example 1 to 100 ppm.

The diesel fuel composition of the present invention may include one or more further additives such as those which are commonly found in diesel fuels. These include, for example, antioxidants, dispersants, detergents, metal deactivating compounds, wax anti-settling agents, cold flow improvers, cetane improvers, dehazers, stabilisers, demulsifiers, antifoams, corrosion inhibitors, lubricity improvers, dyes, markers, combustion improvers, metal deactivators, odour masks, drag reducers and conductivity improvers. Examples of suitable amounts of each of these types of additives will be known to the person skilled in the art.

The present invention relates to reducing the filter blocking tendency of a fuel composition having a tendency to block filters.

By a fuel composition having a tendency to block filters we mean to refer to a fuel composition which, if untreated with an additive as described herein, would cause blocking of filters. The tendency of a fuel composition to block filters may be measured by a number of standard industry tests. The fuel compositions suitable for treatment according to the present invention are fuel compositions which do not satisfy the requirements of such standard tests without the addition of the claimed additives. Reduction of the filter blocking tendency of the fuel compositions may be demonstrated by achieving an improved performance in one of these tests.

One standard test method for determining filter blocking tendency (FBT) is described in ASTM D2068/IP387. This general procedure is commonly used for middle distillate fuels containing biodiesel and biodiesel blends. Another test suitable for measuring filter blocking tendency is set out in IP618. The present invention may be assessed using one of these tests.

A preferred method by which the filter blocking tendency of the present invention can be determined is the Canadian Cold Soak Filter Blocking Tendency test (CSFBT). In this test fuel is stored at 1° C. for 16 hours before the filterability is assessed. The procedure for this test is set out in CAN/CGSB 3.0 No. 142.0-2019 and a modified version in which renewable fuel is used in place of a specified isoparaffinic solvent is described in example 2. A similar test is the European Cold Soak test CS IP387 in which fuel is stored at 5° C. for 16 hours.

In preferred embodiments the present invention reduces the filter blocking tendency of the fuel composition as measured by the method of the CSFBT test. According to the method the CSFBT test fuel compositions are cooled to 1° C. for 16 hours and then tested by filtration to provide a unitless value. The value is an indicator of how likely the fuel is to block filters and a value of less than 2 is generally considered acceptable.

Preferably the present invention reduces the filter blocking tendency of a fuel composition which achieves a CSFBT test result of greater than 2 prior to being treated with an additive according to the invention. Suitably a fuel composition provided by the present invention achieves a CSFBT test result of less than 2.

Preferably the present invention reduces the score of a fuel composition in a CSFBT test by at least 10%, suitably at least 20%, more preferably at least 30%, for example at least 40% or at least 50%.

The invention will now be further described with further to the following non-limiting examples.

### EXAMPLE 1

A commercially sourced fuel composition comprising a blend of 80% by volume of a renewable diesel and 20% by volume of a biodiesel was treated with 250 ppm of an additive comprising an aromatic solvent and about 50% active ingredients including a wax anti-settling additive.

The untreated blended fuel had the following properties:

| Cloud Point, | CFPP, | Pour Point, |
|---|---|---|
| ASTM D7689 (° C.) | ASTM D6371 (° C.) | ASTM D7346 (° C.) |
| 2.4 | 0 | 0 |

### EXAMPLE 2

The unadditised and additised fuel compositions described in example 1 were tested according to a modification of the procedure of the standard CSFBT test method set out in CAN/CGSB 3.0, No. 142-2019.

The summary of the modified test method is as follows:
1. A sample of the fuel composition is first conditioned to erase its thermal history.
2. The fuel composition is then held at 1° C. for 16 h.
3. The fuel composition is then warmed to 25° C. for 2-4 h.
4. After warming, the fuel composition is then passed at a constant rate of flow (20 mL/min) through a glass fibre filter medium (1.6 μm pore size).
4.1. The pressure drop across the filter is monitored until 300 mL of the fuel composition has passed through the filter, and the maximum pressure drop is used to calculate the CSFBT result, or
4.2. If a pressure drop of 105 kPa is reached before 300 mL of the fuel composition is filtered, the volume filtered when 105 kPa is reached is used to calculate the CSFBT result.
5. Results of the CSFBT test can range from 1.0 for a fuel composition with very good filterability (essentially no separated materials under the test conditions), to more than 10 for a fuel composition with poor filterability (a relatively high level of separated materials under test conditions)

The results are shown in Table 1.

TABLE 1

| Fuel | FBT |
|---|---|
| Base fuel | 3.88 |
| Additised fuel | 1.18 |

### EXAMPLE 3

An additive composition A was prepared comprising the components listed in table 2:

TABLE 2

| Component | wt % active | Description of component |
|---|---|---|
| EVA copolymer | 4.0 | copolymer comprising 86.5 mol % |
| | | ethylene and 13.5 mol % |
| | | vinyl acetate having Mn of ~3,600 |
| Terpolymer | 8.1 | copolymer comprising ~85 mol % |
| | | ethylene, ~10 mol % vinyl acetate |
| | | and ~5 mol % 2-ethylhexyl acrylate |
| | | and having Mn of ~4,000 |
| WASA | 6.0 | amide-amine salt formed by reacting |
| | | 1 molar portion of phthalic anhydride |
| | | with 2 molar portions of hydrogenated |
| | | ditallow fatty amine |
| Xylene | 54.2 | |
| Other solvents | To 100 | Including diethylene glycol |
| | | monomethyl ether (DIEGME) and |
| | | solvents from polymer and WASA |
| | | components |

Additive composition A was dosed into a blended fuel comprising 80% by volume of a renewable diesel and 20% by volume of a biodiesel. The biodiesel fuel component had the following fatty acid methyl ester distribution:

| Component | Normalized Totals (wt %) |
|---|---|
| C16:0 | 9.35 |
| C16:1 | 0 |
| C18:0 | 3.88 |
| C18:1 | 36.62 |
| C18:2/3 | 49.08 |
| C20:0 | 0.38 |
| C20:1 | 0.37 |
| C22:0 | 0.32 |
| Total | 100 |

The renewable diesel component of the blended fuel had a cloud point of −11.5° C. and a pour point of −12° C.

The resultant fuel composition was tested according to the method described in example 2.

The results are shown in Table 3.

TABLE 3

| | Additive composition A | |
|---|---|---|
| Fuel | (ppm) | FBT |
| Base fuel | 0 | 3.88 |
| Additised fuel | 1000 | 1.87 |

### EXAMPLE 4

An additive composition B was prepared comprising the components listed in table 4:

TABLE 4

| Component | wt % active | Description of component |
|---|---|---|
| EVA copolymer | 4.0 | copolymer comprising 86.5 mol % |
| | | ethylene and 13.5 mol % vinyl |
| | | acetate having Mn of ~3,600 |
| Terpolymer | 8.1 | copolymer comprising ~85 mol % |
| | | ethylene, ~10 mol % vinyl acetate |
| | | and ~5 mol % 2-ethylhexyl acrylate |
| | | and having Mn of ~4,000 |
| WASA | 3.0 | the reaction product of 1 mole of |
| | | ethylenediamine tetraacetic acid |
| | | and 4 moles of hydrogenated ditallow |
| | | fatty amine. |
| Xylene | 63.3 | |
| Other solvents | To 100 | Including diethylene glycol |
| | | monomethyl ether (DIEGME) |
| | | and solvents from polymer and |
| | | WASA components |

An additive composition C was prepared comprising the components listed in table 5:

TABLE 5

| Component | wt % active | Description of component |
|---|---|---|
| EVA copolymer | 4.0 | copolymer comprising 86.5 mol % |
| | | ethylene and 13.5 mol % vinyl |
| | | acetate having Mn of ~3,600 |
| Terpolymer | 8.1 | copolymer comprising ~85 mol % |
| | | ethylene, ~10 mol % vinyl acetate |
| | | and ~5 mol % 2-ethylhexyl acrylate |
| | | and having Mn of ~4,000 |
| WASA | 3.0 | copolymer of maleic anhydride and |
| | | a C18 α-olefin reacted with 2 |
| | | equivalents of hydrogenated ditallow |
| | | fatty amine. |
| Xylene | 63.2 | |
| Other solvents | To 100 | Including diethylene glycol |
| | | monomethyl ether (DIEGME) and |
| | | solvents from polymer and WASA |
| | | components |

Additive compositions A, B and C were dosed into a blended fuel comprising 80% by volume of a renewable diesel and 20% by volume of a biodiesel. The biodiesel fuel component had the following fatty acid methyl ester distribution:

| Component | Normalized Totals ( wt %) |
|---|---|
| C14:0 | 2.56 |
| C16:0 | 24.65 |
| C16:1 | 2.45 |
| C17:0 | 1.21 |
| C17:1 | 1.14 |
| C18:0 | 18.85 |
| C18:1 | 44.02 |
| C18:2 | 5.11 |
| Total | 100 |

The renewable diesel component of the blended fuel had a cloud point of −11.5° C. and a pour point of −12° C.

The resultant fuel compositions were tested according to the method described in example 2.

The results are shown in Table 5.

TABLE 5

| | Additive composition treat | |
|---|---|---|
| Fuel | rate (ppm) | FBT |
| Base fuel | 0 | 2.90 |
| Base + additive B | 1000 | 1.94 |
| Base + additive C | 1000 | 1.94 |

1. The use of at least one wax anti-settling additive, optionally in combination with one or more further additives, to reduce the filter blocking tendency of a fuel composition having a tendency to block filters, wherein the fuel composition comprises a renewable diesel component and a biodiesel component.

2. A method of reducing the filter blocking tendency of a fuel composition having a tendency to block filters and which comprises a biodiesel component and a renewable diesel component, the method comprising dosing into the fuel at least one wax anti-settling additive and optionally one or more further additives.

3. A fuel composition comprising a renewable diesel component, a biodiesel component, at least one wax anti-settling additive and optionally one or more further additives; wherein the fuel composition has a reduced filter blocking tendency compared with an otherwise identical fuel composition which does not comprise the wax anti-setting additive and has a tendency to block filters.

4. The method according to claim 2, wherein the fuel composition comprises from 5 to 35 vol % of a biodiesel component and from 65 to 95 vol % of a renewable diesel component.

5. The method according to claim 2, wherein the wax anti-settling additive is selected from one or more of:
(a) the reaction product of a polycarboxylic acid having at least one tertiary amino group and a primary or secondary amine;
(b) the reaction product of an α, β dicarboxylic acid or a derivative thereof and a primary amine;
(c) the reaction product of a polyamine and a fatty acid;
(d) the reaction product of secondary amines and a copolymer of maleic anhydride and an α-olefin;
(e) the reaction product an anhydride of a polycarboxylic acid and at least two equivalents of secondary amine;
(f) a spirobislactone derivative; and
(g) a Mannich modified alkylphenol aldehyde resin.

6. The method according to claim 2 wherein the fuel composition comprises a mineral diesel component.

7. The method according to claim 2 wherein the fuel composition does not comprise a mineral diesel component.

8. The method according to claim 2 wherein the wax anti-settling additive comprises (a) the reaction product of a polycarboxylic acid having at least one tertiary amino group and a primary or secondary amine.

9. The method according to claim 2 wherein the wax anti-settling additive comprises (b) the reaction product of an α, β dicarboxylic acid or a derivative thereof and a primary amine.

10. The method according to claim 2 wherein the wax anti-settling additive comprises (c) the reaction product of a polyamine and a fatty acid.

11. The method according to claim 2 wherein the wax anti-settling additive comprises (d) the reaction product of secondary amines and a copolymer of maleic anhydride and an A-olefin.

12. The method according to claim 2 wherein the wax anti-settling additive comprises (e) the reaction product of an anhydride of a polycarboxylic acid and at least two equivalents of secondary amine.

13. The method according to claim 2 wherein the wax anti-settling additive comprises (f) a spirobislactone derivative.

14. The method according to claim 2 wherein the wax anti-settling additive comprises (g) a Mannich modified alkylphenol aldehyde resin.

15. The method according to claim 2 wherein the wax anti-settling additive comprises two or more of component (a), component (b), component (c), component (d), component (e), component (f) and component (g).

16. The method according to claim 2 wherein the one or more further additives includes a copolymer obtained by reacting monomers of:
(x) an α-olefin;
(y) an ester of an unsaturated alcohol; and optionally
(z) a third monomer different to (x) and (y) comprising an alkene functional group.

17. The method according to claim 2 wherein the one or more further additives includes an alkyl phenol resin.

18. The method according to claim 2 which provides an improved filter blocking tendency as measured by the Canadian Cold Soak Filter Blocking Tendency test CAN/CGSB-3.0 No. 142.0-2019.
